(19) United States
(12) Patent Application Publication
(10) Pub. No.: US 2016/0125110 A1
(43) Pub. Date: May 5, 2016

(54) METHOD FOR THE SIMULATION OF FAULTS IN INTEGRATED CIRCUITS OF ELECTRONIC SYSTEMS IMPLEMENTING APPLICATIONS UNDER FUNCTIONAL SAFETY, CORRESPONDING SYSTEM AND COMPUTER PROGRAM PRODUCT

(71) Applicant: Yogitech S.p.A., Loc. S. Martino Ulmiano San Giulian (IT)

(72) Inventors: Riccardo Mariani, Loc. S. Martino Ulmiano San Giuliano Ter (IT); Monia Chiavacci, Loc. S. Martino Ulmiano San Giuliano Ter (IT); Giuseppe Capodanno, Loc. S. Martino Ulmiano San Giuliano Ter (IT)

(73) Assignee: Yogitech S.p.A., Loc. S. Martino Ulmiano San Giulian (IT)

(21) Appl. No.: 14/866,089

(22) Filed: Sep. 25, 2015

(30) Foreign Application Priority Data
Sep. 26, 2014 (IT) TO2014A000763

(51) Int. Cl. G06F 17/50

(52) U.S. Cl. CPC G06F 17/5036

(57) ABSTRACT

A method for simulating faults in integrated circuits of electronic systems implementing applications under functional safety includes operating a simulation step of the system or electronic circuit on a processing system and executing the application under functional safety. The simulation step has a fault injection procedure including injecting a set of faults during simulation in determined locations, and verifying if observation points and diagnostic points connected to determined root failure modes are perturbed. The simulation step includes before the injecting step during simulation in determined locations of an electronic circuit performing a procedure to select a set of effective faults, pertaining only to effective root failure modes, which allow obtainment of the overall diagnostic coverage target, and supplying the set of effective faults for the execution of the injecting step during simulation in determined locations of the electronic circuit.

### TECHNICAL FIELD

The present description refers to techniques of simulating faults in integrated circuits of electronic systems or electronic circuits implementing applications under functional safety. The described techniques envisage operating a simulation step of said electronic system or circuit on a processing system that has the application under functional safety in execution, and during this simulation step a procedure of injecting faults is executed, comprising injecting faults during the simulation step in determined locations of the electronic system or circuit, verifying if observation points and diagnostic points connected to determined root failure modes are perturbed by the injected fault.

Various embodiments can be applied to the functional safety. In particular, various embodiments are applied in electronic systems in the field of industrial robotics and industrial controls, and in the technical field of electronic systems for automotive applications for assisting the operator and partially or completely automatic driving.

### TECHNOLOGICAL BACKGROUND

The regulations for the functional safety, such as the regulation IEC 61508 and the regulation ISO 26262 require the adherence to certain metrics, or measure standards, analogous to the software metrics, such as the “diagnostic coverage”, suitable for quantifying the level of integrity of a certain electronic apparatus used in contexts that contemplate critical applications, such as the industrial field and the automotive field.

The aforementioned regulations require verifying the adherence to said metrics by means of operations of so-called “injection of faults”, or rather, a form of verification that envisages the intentional injection of malfunctions in order to ascertain that these faults do not have effects on the application, or they are detected by suitable control systems.

In the case of integrated circuits, for which it is impossible or impracticable to inject faults into the finished device—consider the difficulty of causing a short circuit within an integrated circuit composed of millions of transistors—operations of injecting faults are usually carried out during the step of developing the electronic apparatus, by means of simulations executed by suitable calculation tools.

However, some disadvantages can render this procedure extremely expensive and sometimes—for very complex circuits—unfeasible.

A concrete example of these disadvantages is the case of injecting transient faults, such as the so-called the “soft errors”, whose model consists in temporary changing the state of a register. This model allows emulation of the effect, for example, of radiation, such as alpha particles, which perturbs the state of a memory element which are the registers. These “soft” type of faults must be injected during any of the instants of execution (or better still, of the simulation of the execution) of one reference application. For complex electronic circuits, this reference application can be very long (for example, over a period of 10 ms). If, therefore, an electronic circuit composed of 100000 registers and with a clock frequency of 10 ns is considered, there are therefore 10 ms/10 ns*100000=100 billion faults. Since a modern calculation tool is typically able to inject a fault every 2 minutes, even if thousands of calculation tools were arranged in parallel, approximately 380 years would be required in order to complete the injection campaign. Therefore, a first disadvantage is represented by the long simulation times due to the interaction between the complexity of the circuits and multiplicity of potentially significant instants for the simulation.

Another disadvantage is due to the frequent necessity by the producers of integrated circuits to implement the derivatives of an electronic data component, or rather, a new generation of the same architecture in which certain changes have been made. Therefore, the procedures described above would require repeating the operation of injecting faults, multiplying, in this way, the cost and time caused by the drawbacks discussed above for each new derivative. In the previous example, this would mean repeating a campaign 380 years for a number of times typically up to ten, this being the typical number of a sequence of derivatives.

FIG. 1 schematically shows the failure modes, which are identified as part of the verification procedure of the functional safety of electronic systems for critical applications. These failure modes correspond to incorrect conducts of the device or electronic system regarding its specific conducts. These failure modes relative to the device or system, said final failure modes FFM, are represented, for example in the automotive field, by events such as the “non-application of the braking force when required by the driver”. As can be seen in FIG. 1, if the electronic system is broken down into its subsystems and components, these final failure modes FFM can be connected using simple logic operations represented by logic gates PL, such as AND or OR) by levels of other resulting failure modes, SFM, other “root” failure modes, RFM, or rather linked more directly to the system components. For example, in the case of an integrated circuit, a root failure mode RFMa can be “miscalculation by the processor” that in OR logic with another root failure mode RFMb “incorrect address by the processor in access to the memory” can constitute a higher failure mode (“resulting” failure mode RSM) which, for example, could be incorrect operation of the processor. Combining one or more failure mode levels results in reaching the final failure FFM in the end, which, as said, is therefore a logical combination of root failure modes RFM.

In the systems for critical applications, required by the international regulations IEC 61508 and ISO 26262, the realization of safety mechanisms is carried out, able to prevent or to reveal these failure modes. For example, in the event of integrated circuits, a safety mechanism can be software executed periodically during the normal operation of the device in order to test all the instructions of a processor.

The international regulations IEC 61508 and ISO 26262 require that these safety mechanisms reach certain values of “diagnostic coverage”, or rather, a certain ratio between the number of the dangerous failures (or rather those able to perturb the critical mission of the system) and the number of faults revealed by the diagnostic mechanism.

In this case, the scope of the verification of the functional safety is that of verifying that—given the total of possible failures—the number of dangerous failures and the number of failures revealed from the diagnostic mechanism are those that are preventative in the planning step of the electronic system.

In FIG. 2, elements and steps are schematically illustrated of a verification of the functional safety in an integrated circuit, indicated by the numerical reference 11, subjected to verification. In FIG. 2, a fault G is represented, injected at a location LC, in the integrated circuit 11 under verification. Letters x, y, . . . , z indicate a plurality of outputs designed in the integrated circuit 11 under verification. One function f(x, y, . . . , z) of these outputs designated x, y, . . . , z represents an observation point O of the fault G. A second function G(x, y, . . . , z) of the outputs designated x, y, . . . , z represents a diagnostic point D. Of course, these magnitudes and the connected operations and functions are defined for a simulation step of the integrated circuit 11 under verification, for example through a computer 600 which can load into its memory and execute a computer program 610, in particular on a computer support, or computer-readable non-transitory means, which comprises one or more of the operations of the method described here, even if, in general terms, these operations could be executed on the physical circuit, even with the difficulties discussed previously.

This verification of the functional safety can be incorporated into a simulation step of the electronic system or electronic circuit 11 with injection of faults 100, which, typically, as also represented in the flow diagram of FIG. 6, comprises:

injecting 110 faults G during the simulation step (for example, “stuck-at” faults) of the circuit 11 at determined locations LC of this circuit 11;

verifying 120 if a certain function f(x, y, . . . , z) of the outputs designated x, y, . . . , z, or observation point O is perturbed by the fault, or rather if the observation point O has a different measured value from an expected value. In this case, the fault G is defined as a potentially dangerous fault GP, in the opposite case it is a “safe” fault GS, or rather, it does not cause a failure of the critical mission. The designated outputs x, y, . . . , z are the outputs of the integrated circuit whose combination can exactly determine the root failure mode. For example, the root failure mode “miscalculation by the processor” has outputs designated as the outputs of the processor;

in the event of a (potentially) dangerous fault GP, verifying 130 if a second function G(x, y . . . z) of the outputs corresponding to the safety mechanism (defined “diagnostic point”, D) is activated (or rather, for example, the value of G(x, y . . . z) differs from a pre-calculated value) from the dangerous fault GP, or rather if, when the observation point O assumes a different measured value from that expected at step 120, the diagnostic point D is activated within a certain interval of time identified by the safety specifications of the electronic device 11. If the diagnostic point D is activated, a dangerous fault condition DGP is revealed, otherwise step 130 gives a dangerous fault condition not revealed NGP. For example, in the case in which the safety mechanism is periodically executed software, the diagnostic point D is represented by the register of the processor or by the memory location in which the software deposits its measured value, to be compared with a pre-calculated value of the test (that is, the expected value without faults).

Usually, the injection of faults occurs while a workload generator is executing commands, in particular, for example, an application under functional safety, to the electronic system. Monitoring modules are provided in order to trace the execution of the commands and to collect the data, for example, from the said points of observation, and analysis modules, which carry out, for example, evaluations of the dangerous faults, for example, according to FMEA analysis. All these modules can be software modules executed on a computer which, in general terms, carries out the simulation procedure. Similar procedures are described, for example, in the U.S. Pat. No. 7,937,679 by the Applicant.

Therefore, based on what has been previously discussed, in the case of complex integrated circuits, the functional verification procedure by means of injection of faults presents at least the following disadvantages: in the absence of a selection strategy, the number of faults G to inject can be enormous (hundreds of millions); the complexity of the integrated circuit is such that it is not simple to identify the observation points O and the diagnostic points D; the length of the test within which to inject the faults is considerable and therefore, multiplied by the number of faults to inject, involves an unacceptable duration of simulation, even when running parallel simulations; every time that the producer changes something in the electronic component, it is necessary to repeat the entire “injection campaign”.

### OBJECT AND SUMMARY

The embodiments described here have the object of improving the potentialities of the methods according to the prior art as discussed previously, in particular to allow the injection of faults in simulation with a much lower time period.

Various embodiments achieve this object thanks to a method having the characteristics referred to in the following claims. Various embodiments can also refer to an architecture as well as to a computer program product, loadable in the memory of at least one computer (for example, a network terminal) and comprising portions of software code suitable for executing the steps of the method during the moment in which the program is executed on at least one computer. As used here, this computer program product is intended to be equivalent to a computer-readable means containing instructions to control the computer system so as to coordinate the execution of the method according to the invention. The reference to “at least one computer” is designed to emphasize the possibility for the present invention to be implemented in a modular and/or distributed form. The claims form an integral part of the technical disclosure provided here in relation to the invention.

Various embodiments can envisage that the method comprises operations that include:

identifying which and how many faults to inject as a function of the objective of diagnostic coverage and according to the connection between the failure modes of the integrated circuit and its elementary parts;

identifying a “window of opportunity” of the reference application within which to inject the faults;

saving the intermediate states of the simulation and their use to reduce the interval of time effectively simulated for every injection concentrated it around the “window of opportunity”;

identifying how many faults must be re-injected in one derivative of an integrated circuit already injected previously with the method described here;

a calculation tool in the form of a simulator, or rather, a processing system configured to execute the simulation method indicated above.

Combining these methods and their implementation by means of the calculation tool consequently allows the reduction of the number of faults to inject, and therefore reduction of the times of injection, by four or more orders of magnitude—with the result of a considerable cost reduction of the verification of the functional safety.

### BRIEF DESCRIPTION OF THE FIGURES

Various embodiments will be now described, purely by way of example, with reference to the attached figures, wherein:

FIG. 1 and FIG. 2 have already been previously described;

FIG. 3 is a diagram illustrative of elements and operations of the principle of operations of the method described herein;

FIG. 4 and FIG. 5 show a temporal diagram of magnitudes relative to the method described here;

FIGS. 6-10 show flow diagrams of procedures employed by the method described here;

FIG. 11 shows a flow diagram of an embodiment of the method described here.

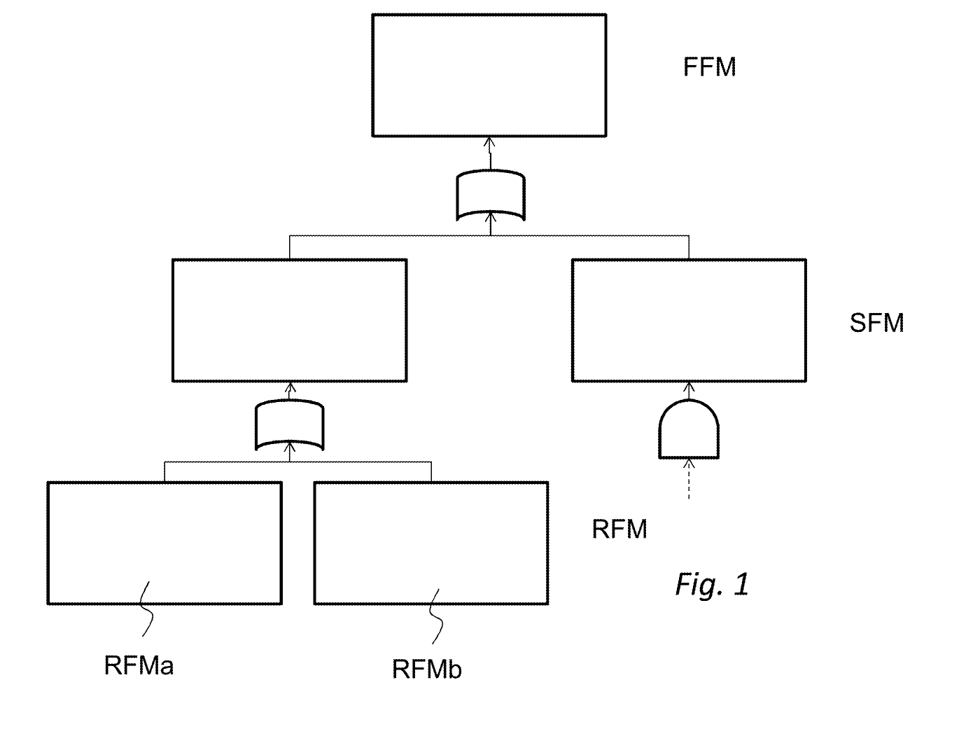

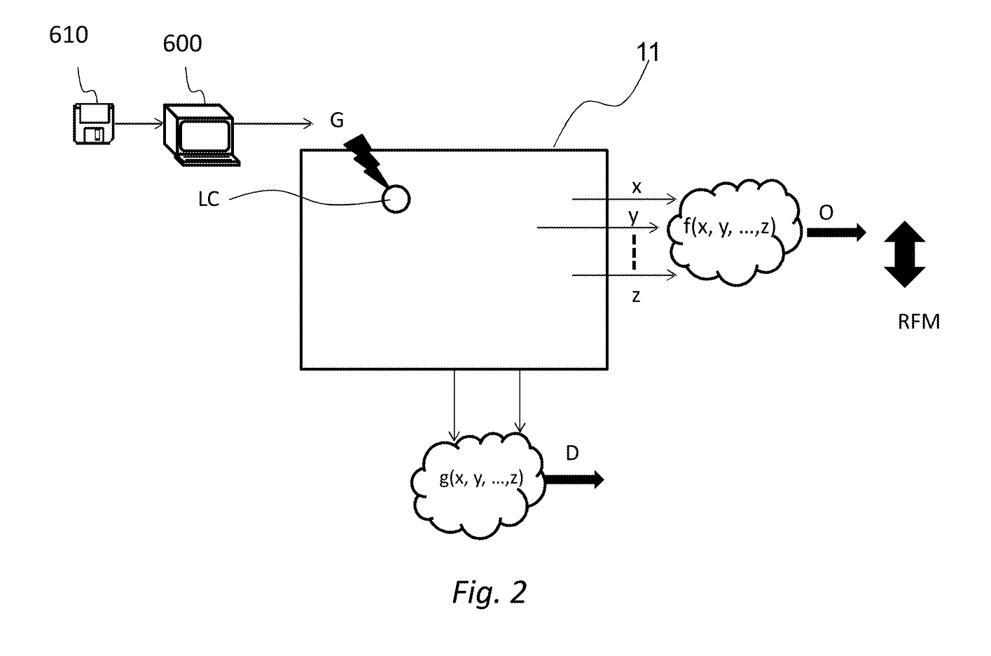

### DETAILED DESCRIPTION

In the following description, numerous specific details are provided with the aim gaining the maximum understanding of the exemplificative embodiments. The embodiments can be implemented with or without specific details, or with other methods, components, materials, etc. In other circumstances, material structures or well-known operations are not shown or described in detail in order to avoid obscuring aspects of the embodiments. The reference during this description to “an embodiment” means that a particular feature, structure or characteristic described in connection with the embodiment is comprised in at least one embodiment. Therefore, use of the phrase “in an embodiment” in several points in this description is not necessarily referring to the same embodiment. Moreover, the particular features, structures or characteristics can be combined in any convenient way in one or more embodiments.

The headings and references are only provided here for convenience of the reader and they do not define the scope or the significance of the embodiments.

As already previously discussed, in the case of complex integrated circuits, the simulation of an electronic circuit or system with functional verification by means of injection of faults presents the following disadvantages: in the absence of a selection strategy, the number of faults G to inject can be enormous (hundreds of millions); the complexity of the integrated circuit is such that it is not simple to identify the observation points O and the diagnostic points D; the length of the test within which to inject the faults is considerable and therefore, multiplied by the number of faults to inject, involves an unacceptable duration of simulation, even when running parallel simulations; every time that the producer changes something in the electronic component, it is necessary to repeat the entire “injection campaign”.

It can be observed here that these disadvantages are closely linked to each other, i.e. the solution of only one of them does not result in significant advantages. The method described here is thus based on a complex strategy able to resolve the disadvantages as a whole.

The simulation method described here overcomes these disadvantages by defining procedures comprising operations suitable for diminishing the number of injected faults concentrating the injection in points of the circuit and significant temporal intervals and by means of implementing a corresponding calculation tool.

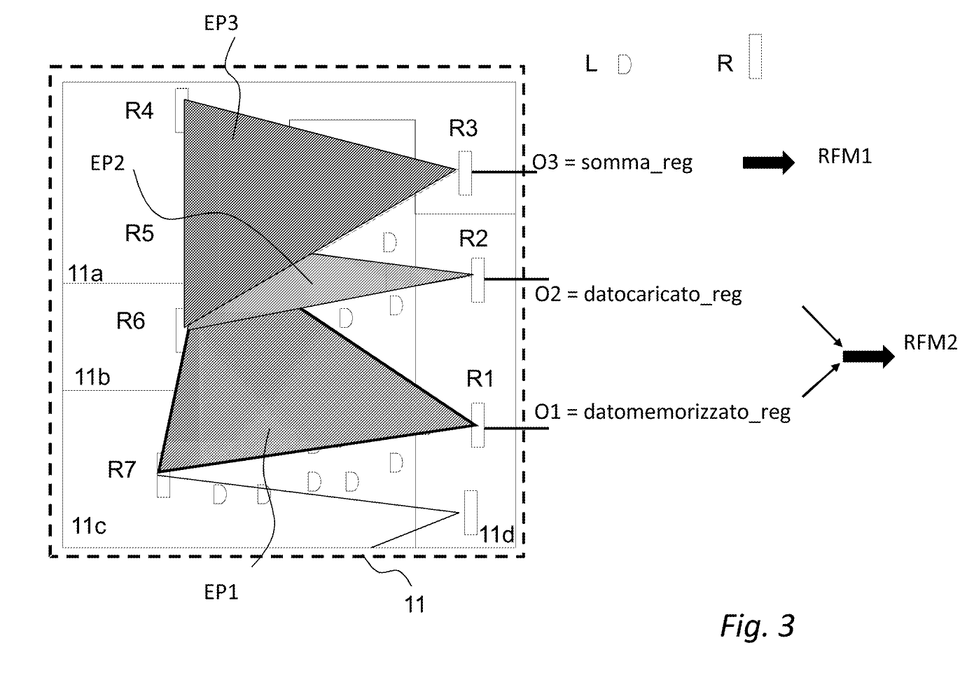

With reference to FIG. 3, a simulation procedure of faults is described, which allows selection and therefore reduction of the number of faults to inject during the injection step.

In FIG. 3, an example of an electronic circuit 11 to simulate is shown. This electronic circuit 11 is comprised, per se, of subparts, in the example of FIG. 3, a logic arithmetical unit 11a, a register block 11b, a floating point unit 11c, and a loading and memorization unit 11d.

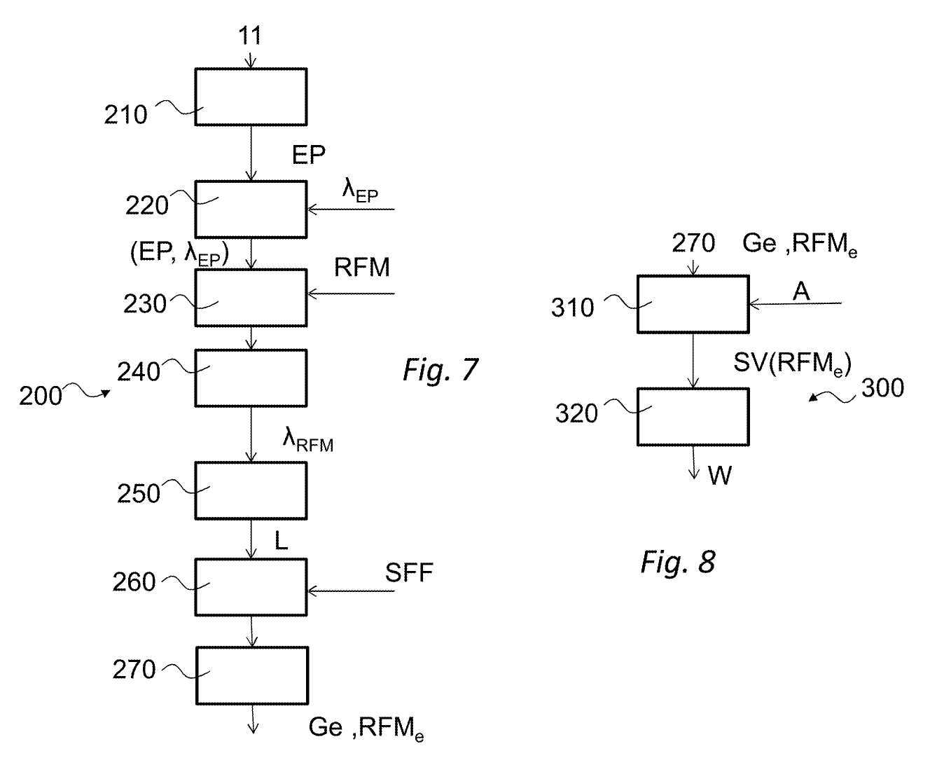

The simulation procedure described here, also shown in the flow diagram of FIG. 7, which is indicated as a whole by reference 200, envisages, in an operation 210, the subdivision of this circuit 11 and subparts 11a . . . 11d by means of another partition into additional subparts, or elementary parts EP. Here, elementary part means the set of a register and the logic cone, or cone of logic, which generates its input state. For simplicity, an elementary part is also indicated below with the name of the register with which it is associated. The granularity of these elementary parts EP depends on the available information. A minimal level of granularity can envisage the selection as elements of the set that composes an elementary part EP, the registers R of the circuit 11 and the logic gates L.

A subdivision operation 210 can, in particular, be carried out in a manner described in the U.S. Pat. No. 7,937,679, in particular in the description pertinent to FIG. 3 of this document. In other words, it is possible to read the description of the circuit under simulation, at one of the various levels of abstraction to which this description is prepared. This reading can comprise an analysis or parsing of the description RTL, at the logic-gate and layout level by means of an EDA (Electronic Automation Design) tool, such as VHDL (VHSIC Hardware Description Language) or the description analyzers of VERILOG circuits. In the same way, the true and actual subdivision 210 into elementary parts EP, still at the RTL level, at the logic-gate and layout level can be carried out employing automatic procedures available in these tools. More specifically, for an integrated digital circuit such as the circuit 11, represented at the gate-level abstraction level, it is envisaged to start from the “net-list”, which is automatically generated at the end of a software synthesis process of a digital circuit. This net-list is, for example, typically, in VERILOG language or in a specific format of the synthesis tool employed. This net-list contains the description of all the logic gates of the integrated circuit and their interconnections. Starting from this net-list, it is possible, through commands included in these synthesis tools, to extract a complete list of the registers from this net-list. This list is usually compacted by means of a PERL script that groups the registers according to their identification name or analogous computer program. Since the list originates from a description at the RTL level (register-transfer-level), the registers are the base elements of this description and are therefore employed in order to identify the elementary parts EP, which, as said comprise the receiving register and the logic cone that generates its state, as better described again with reference to FIG. 3, extended or rather, the set of circuital elements which pertains to a data register. In fact, once the registers to which the elementary parts EP pertain are identified, extraction of the information relative to the input logic cones and/or the output cones corresponding to each register is envisaged. This information relative to the logic cones comprises the composition of the logic cone, for example in terms of counting the gate number (which can serve for calculating the area of the cone), counting the PINs, the number of sources (inputs of the input logic cone) and the number of loadings (outputs of the output logic cone), interconnections and other values, known per se in the state of the art. In particular, by way of example, but not limiting, in the case of a gate-level description, this information is extracted from the netlist, employing commands available in the synthesis tool, in order to extract the gates that compose the “fan-in” and “fan-out” of each elementary part EP, intended as a register. The gate count values and other values can be calculated with specific script, based on these fans-in and fans-out. By way of example, a synthesis tool for Verilog, such as the Synopsis tool comprises, for this purpose, the commands “transitive_fanout” and “transitive_fanin”, which extract from the description of the circuit number and type of logic gates in the input logic cone in a data register, or which start from the register, in an output logic cone. According to this information, it is then straight-forward to calculate the number of gates (gate count), which, as said, can be employed as a measure of the area of the logic cone.

The information on elementary parts EP and their composition can be inserted into informative structures, such as a database with a record for every elementary part EP, containing information on the gates that the input and/or output logic cone comprises and one or more of the extracted parameters discussed above, such as the gate count.

In FIG. 3, three elementary parts EP3, EP2, and EP1 are shown, in particular, which correspond to the input logic cones that pertain, respectively, to:

an R3 register, dislocated in the ALU 11a, starting from the R4 registers in the ALU and R6 in the block registers 11b, implementing, by way of example, a function corresponding to an observation point O3, of the sum of registers, or somma_reg,

an R2 register, in the LSU 11d, from the R5 registers in the ALU 11b and R6 in the block registers 11b, implementing, by way of example, a function corresponding to an observation point O2, of loaded data, or datocaricato_reg,

an R1 register, in the LSU 11d, from the R5 and R7 registers in the FPU 11c, implementing, by way of example, a function corresponding to an observation point O1, of memorized data, or datomemorizzato_reg.

With the observation point O3, a root failure mode RFM1 is associated, relative to an incorrect value produced by the sum operation. With the observation points O2 and O3, a root failure mode RFM2 is associated, relative to an incorrect value loaded from the memory or sent to the memory.

Still with reference to the flow diagram of FIG. 7, the calculation of a failure rate for each elementary part λ_{EP} characterized at step 210 is then envisaged (step 220), for example using the method described in the U.S. Pat. No. 7,937,679 (note in particular the calculation of the cumulative failure rate for the responsive zones, corresponding to the elementary parts, described in column 10 line 31 to column 11, line 42 of U.S. Pat. No. 7,937,679, whose material is here considered incorporated for reference), or rather attributing a failure rate to each of the elementary functions, for example logic gates L and registers R or flip flop, which constitute the elementary part EP.

Then (step 230), the elementary parts EP are grouped and connected according to respect root failure modes RFM. This grouping can be carried out using, also automatically, for example the “name” of the elementary part EP, or rather the register name to which it belongs (for example, /processore/ALU/somma_reg) in order to characterize the functionality (in this case “sum”) to which to connect the root failure mode RFM. This grouping is analogous to the cited grouping of the registers through a PERL script for compacting the list of the registers. Alternatively, this step 230 can be implemented completing a detailed analysis of the physical implementation of the circuit suitable for identifying the functionality to which every elementary part EP contributes. This can be manual or through a computer program, for example, a script configured for this analysis and detailed grouping or to a specific computer program not linked to off-the-shelf tool commands such as a script.

Then (step 240), to each root failure mode RFM is assigned one a failure rate λ_{RFM} resulting from the sum of the failure rates λ_{EP} of the elementary parts EP that constitute it.

The root failure modes RFM (step 250) are arranged in a list LF in which the root failure mode RFM that has the highest failure rate λ_{RFM} is placed at the top of the list, and so on in a decreasing order. Of course, an increasing order is also possible.

In step 260, an estimation is made—for each root failure mode RFM—of the fraction of dangerous failures of these totals, for example, evaluating the SFF (Safe Failure Fraction). This SFF value, which is also that indicated in the last column in Table 1 below, is calculated based on safeness S and diagnostic coverage DC, in particular SFF=S+DC (SFF=(safe failures+dangerous failures detected)/total failures=S+DC).

In a step 270, all the effective faults Ge are finally selected for the injection, or rather the faults G afferent to the elementary parts EP of effective root failure modes RFMe, or rather, the root failure modes that result in being capable, if the corresponding estimates SFF are confirmed, of reaching the overall objective of diagnostic coverage defined by the international standards.

Table 1, below, corresponds to the list LF of the step 250, or rather the portions of circuit from which to select the faults.

TABLE 1

| | | | Estimated |
|---|---|---|---|
| Failure | Elementary | Failure | dangerous |
| mode | parts | rate | failures/total |
| RFM | EP | λ_{RFM} | failures SFF |
| RFM2 | EP1, EP2 | 64.4% | 100% |
| RFM1 | EP3 | 30.6% | 0% |
| RFM3 | EP . . . . | 5.0% | 90% |

| | | |
|---|---|---|
| TOT | 100% | 68.9% |

It should be noted that it is equally possible to have two tables like Table 1, one having the safeness S in the last column, and the other diagnostic coverage DC.

In step 270, in this case, RFM2 is selected as the effective root failure mode RFMe, and consequently all the faults G afferent to the elementary parts EP that concur to this mode RFM2 are selected for the injection.

From the example of FIG. 3, it can be seen that this procedure significantly reduces the number of faults to inject, because only those relative to the elementary parts EP1 and EP2 are verified through injection of faults.

Steps 210-270 therefore allow selection of how many and which are the “indispensable” faults to inject.

The method envisages, moreover, to estimate when to inject these faults, in order to avoid that these faults must be injected throughout the entire time frame of the reference application used for the simulation. This is obtained through additional steps.

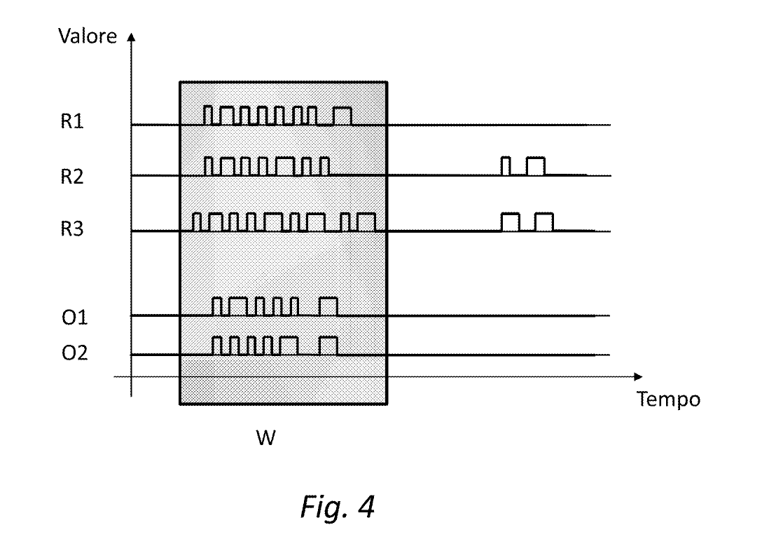

With reference to the temporal diagram of FIG. 4, which reports the function of the time values assumed from observation points O1, O2 and registers R1, R2, R3, and to the flow diagram of FIG. 7, where an additional method 300 is described, it is therefore also envisaged to:
simulate 310 the reference application, indicated by A, generating the simulation values SV for all the registers of the elementary parts EP which have been selected at step 270 for all the observation points O relative to the effective root failure mode RFMe under examination;
select 320 one or more “windows of opportunity” W, or rather, in particular, temporal windows in the duration time of the simulation, within which to inject faults in an equidistributed manner, as portions of the simulation in which there is the maximum activity of the registers, for example R1, R2, R3, to which the elementary parts EP belong, for example, respectively EP1, EP2, EP3, and of the observation points O, for example, respectively O3, O2, O1. Activity signifies, in the digital circuits, the change of state of the signal from zero to one or vice versa. In order to calculate the maximum activity, in particular, for example, all the windows that have a value of activity greater than a threshold are selected, defined on the basis of the circuit and the level of required safety, for example greater of 50%

The selection 320 of the windows of opportunity W allows reduction of the time valid for injection by several orders of magnitude.

In order to improve the effectiveness of the method described here, it is envisaged that the simulation method can then quickly arrive at the instant during the simulation in which the window of opportunity W is opened, without having to wait for all the time that elapses, which, in certain cases, can be very high. Take, for example, a generic simulation of a microcontroller where one wide initial portion is formed by the initialization procedure of the processor in which a large part of the circuit is, in fact, inactive: this portion is not included in the windows of opportunity W, but occupies an important part of the simulation time.

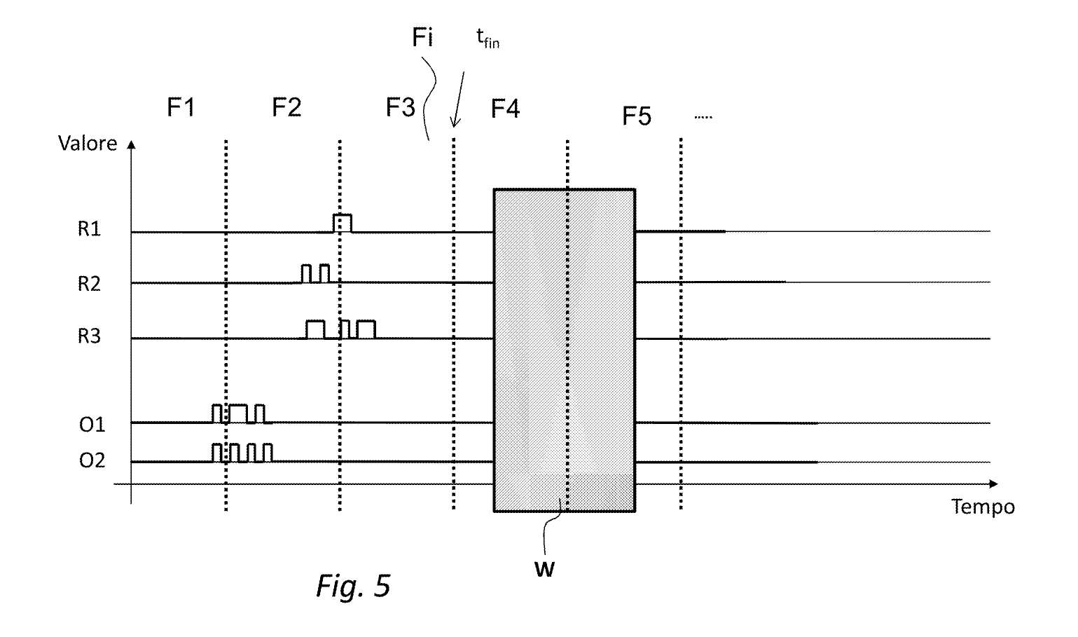

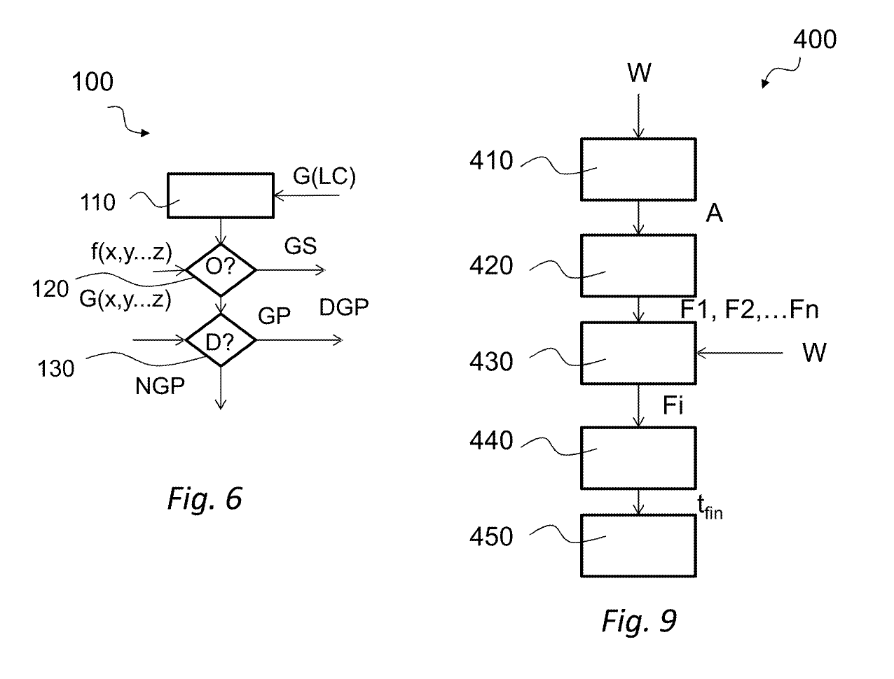

To this end, an additional method 400 is provided, which, with reference to the temporal diagram of FIG. 5, that traces the same magnitudes of the diagram of FIG. 4, comprises:

executing 410 a simulation of the reference application A without faults,

saving 420 the “snapshots” F1, F2, . . . Fn of the simulation at regular intervals of time, or rather saving the state of all signals of the electronic circuit 11,

identifying 430 which snapshot Fi immediately precedes the window of opportunity W. In FIG. 5, it is the snapshot F3.

loading 440 this identified snapshot Fi, or rather loading in the simulation, the state of all the signals of the memorized electronic circuit 11 in this snapshot Fi, and

starting 450 the simulation of the circuit 11 from the final instant t_{fin} of the selected snapshot Fi.

In this way, step 440 allows further reduction of the simulation time avoiding the simulation of “useless” intervals, those in FIG. 5 F1 . . . F3, of the reference application A, or rather intervals in which there are no windows of opportunity W to inject.

The method comprises, moreover, a method 500 for defining a strategy for identifying which faults are injected, in the case of a new circuit 21 obtained as a modification of a previously injected one, for example, circuit 11. The circuit 21 is defined as derivative, or rather an electronic circuit derived from a preceding circuit.

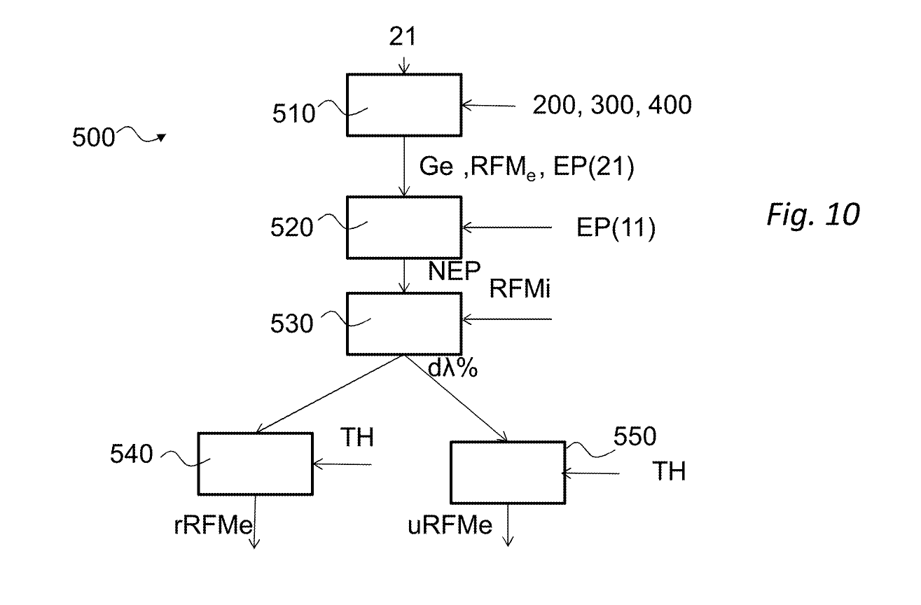

This method 500 comprises, with reference to the flow diagram, steps comprising, with reference to the diagram of FIG. 10:
defining 510 the root failure modes RFM for the derivative circuit 21 and repeating the procedure of connection 220-230 with the elementary parts EP and selecting 270 the root failure modes RFM to inject, as previously described, or rather, the procedure 200. Of course, step 510 can envisage that the procedure 300 is also executed in order to identify one or more windows of opportunity W, or the procedure 400 in order to start the simulation in proximity of the window of opportunity W;
counting 520, in particular as a percentage value, how many elementary parts EP of the derivative circuit 21 do not find a correspondent in the elementary parts EP that have been previously determined, by means of the procedure 200, for the circuit 11, or rather, how many non-correspondent parts NEP there are;
calculating 530, for a given root failure mode RFMi to be injected, a “distance” dλ %, in percentage value between one cumulative failure rate of the circuit 11, or rather the sum of the failure rates λ_{RFM} of the elementary parts EP connected to the selected root failure mode RFM, and the correspondent cumulative failure rate of the derivative circuit 21;
selecting 540 the failure modes rRFMe to reinject into the derivative circuit 21 from the modes RFMe determined at step 510, in particular those which have a number of different elementary parts NEP greater than a prefixed threshold TH or which have a greater distance dλ % than said prefixed threshold TH; in alternative to the re-injection, the expert in the field can analyze each identified different elementary part NEP at step 510 and evaluate the reason for this difference, and then decide if it is necessary to re-inject or if it is possible to deduce the result of the injection from those of the analogous elementary parts EP of the circuit 11;
selecting 550 the failure modes RFM and identifying, at step 510, which of the results of the injection of the circuit 11 can be reused, such as those which have a different number of elementary parts EP lower than the said prefixed threshold and which have a smaller distance of the said prefixed threshold.

The prefixed threshold percentage TH is set up, in particular by an expert technician, according to the provided safety mechanisms and according to the type of circuit: for example if a circuit envisages a total redundancy as a safety mechanism, the threshold TH can be raised (for example 40 or 50%) as it is, however, guaranteed that the faults will be revealed and therefore the new injection is superfluous. If instead the circuit envisages a safety mechanism such as, for example, a periodic test for which it is not possible to know, at first, if it will be able to cover the elementary part that differs, then the threshold TH is kept low (for example 20%).

In the following Table 2, the decisions taken are summarized according to threshold TH by means of:

TABLE 2

| NEP | dλ% | Decision |
|---|---|---|
| <TH | <TH | Reuse the results |
| | | of injection of |
| | | the circuit 11 |
| >TH | Any | Repeat the |
| Any | >TH | injection. |

The procedure 500 allows the drastic diminishing of the number of faults to inject for every new derivative circuit.

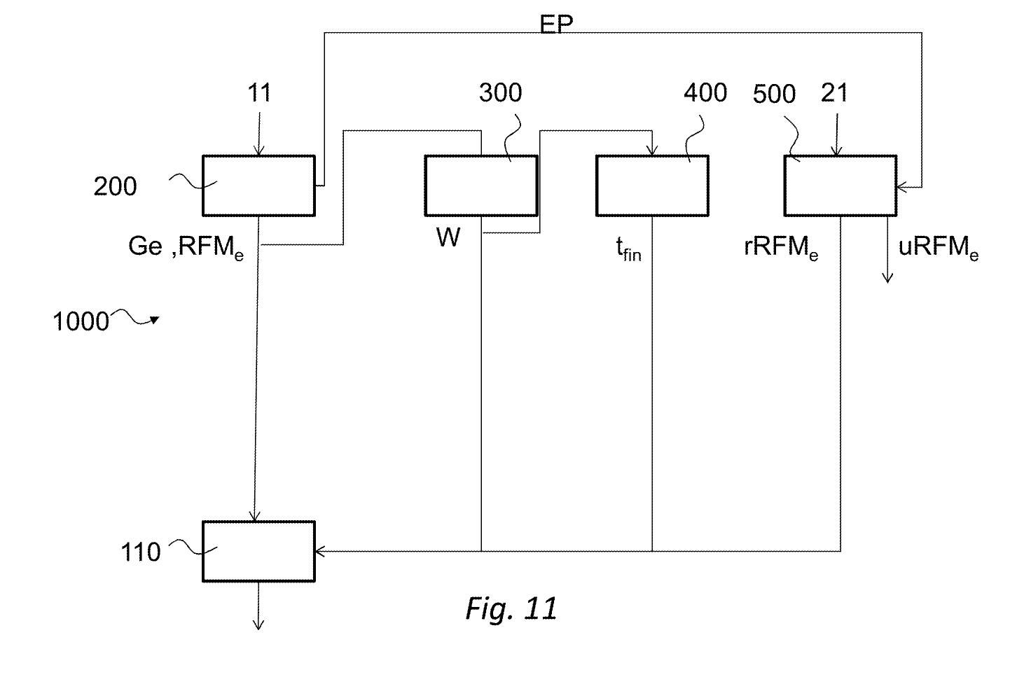

FIG. 11 shows the method of simulating faults in integrated circuits of electronic systems implementing applications A under functional safety in its entirety. This method, indicated by reference 1000, above all comprises applying the procedure 200 to the circuit 11 and obtaining the effective failures Ge to inject, as well as the effective root failure modes RFMe, that is, the root failure modes that result in being able to, if the correspondents estimations SFF are confirmed, to reach the overall objective of diagnostic coverage defined by the international standards. These effective failures Ge are passed to step 110 of injection of faults during the simulation step. Downstream of this step 110 it is envisaged to monitor the observation points and/or diagnostic points in order to identify dangerous failures GP.

Additionally, with respect to the procedure 200, it is possible, based on the effective failures Ge to inject, as well as effective root failure modes RFM selected from the procedure 200, to apply a procedure 300 in order to identify a window of opportunity W in which to operate the simulation step 110 of the application with injection of faults.

Additionally, with respect to the procedure 300, it is possible, based on one or more identified windows of opportunity W, through the procedure 400, to memorize snapshots F1 . . . Fn of the simulation of the circuit 11 at various intervals and to identify an instant of time t_{fin}, relative to the end of a snapshot Fi immediately preceding the beginning of the window of opportunity W with respect to which to start the simulation 110 with injection of effective faults Ge.

Additionally, with respect to the procedures 200, 300, 400, the method 1000 can comprise, when the electronic circuit is a derivative circuit 21, or rather derived from an electronic circuit 11 for which the procedure 200 has been executed, or both the procedure 200 plus the procedure 300 or the procedure 200 plus the procedure 300 plus the procedure 400, the execution of a procedure 500 which, through the comparison of elementary parts EP obtained at the procedure 200 on the circuit 11, with the elementary parts EP obtained by applying the procedure 200 on the derivative circuit 21, identifies effective root failure modes rRFMe to re-inject with respect to only those to execute the operation 110 as a re-injection process. In addition, the procedure 500 also identifies effective root failure modes uRFMe for which they can be reused, as results of the simulation, the results previously obtained by injecting faults for the circuit 11, without repeating the injection step 110.

Therefore, from the description, the advantages of the invention are clear.

The method and system described advantageously allow identifying which and how many faults to inject as a function of the objective of diagnostic coverage and according to the connection between the failure modes of the integrated circuit and its elementary parts.

The method and system described advantageously allow identifying a “window of opportunity” of the reference application within which to inject the faults.

The method and system described advantageously allow saving the intermediate states of the simulation and their use to reduce the interval of time effectively simulated for every injection concentrating it around the “window of opportunity”.

The method and system described advantageously allow identifying how many faults must be re-injected in one derivative of an integrated circuit already injected previously with the procedures according to the method described here;

Various combinations of the procedures described and their implementation by means of a calculation tool consequently allows the reduction of the number of faults to inject, and therefore reduction of the injection times, by four or more orders of magnitude—with the result of a considerable cost reduction of the verification of the functional safety.

Of course, without prejudice to the principle of the invention, the details and the embodiments can vary, even significantly, with respect to what is described here purely by way of example, without deviating from the field of protection. This field of protection is defined by the attached claims.

The method described here refers to the implementation for the simulation on at least one processor or computer, which, as said, can be an implementation in a modular and/or distributed form, for example on an architecture of server processors.

The method of simulating faults into integrated circuits of electronic systems implementing applications in functional safety with injection of faults described here, as indicated previously, can be integrated as a step, also recursive, of design procedures of electronic systems or circuits (EDA, Electronic Design Automation).

These design procedures are usually associated, in a production process of the electronic system, with a physical production step, at the silicon foundry level, of the electronic system and also with a production step of a program that is executed on this electronic system, based on the results of the design procedures, in turn including one or more applications of the described simulation method. For example, the design procedure described here is part of the production process of highly reliable microcontrollers such as those described in the U.S. Pat. No. 7,472,051 by the same Applicant.

1. A method for simulating faults in integrated circuits of electronic systems implementing applications under functional safety, comprising operating a simulation step of said system or electronic circuit on a processing system, executing said application under functional safety, said simulation step comprising a fault injection procedure comprising:
injecting set of faults during simulation in determined locations of said system or electronic circuit;
verifying if observation points and diagnostic points connected to determined root failure modes are perturbed by the injected faults,
said simulation step comprising, before said step of injecting a set of faults during simulation in determined locations of an electronic circuit:
performing a procedure to select a set of effective faults from said set of faults to inject, pertaining only to effective root failure modes, which allow obtaining the overall diagnostic coverage target,
supplying said set of effective faults for the execution of said step of injecting faults during simulation in determined locations of said electronic circuit under simulation.

2. The method according to claim 1, wherein said procedure of selecting a set of effective faults comprises:
subdividing said electronic circuit into elementary parts comprising sets of circuit elements which contribute to determining a function associated with a given point of observation;
calculating a failure rate associated with each elementary part,
grouping the elementary parts according to their respective root failure modes,
assigning a respective failure rate to each root failure mode resulting from the sum of the failure rates of the elementary parts associated therewith,
listing said root failure modes according to a failure rate order, in particular a decreasing order,
associating an estimate of the fraction of dangerous failures over the total failures with each root failure mode,
selecting for injection all faults relating to the elementary parts of the root failure modes that, based on the corresponding estimates, are able to reach an overall diagnostic coverage target.

3. The method according to claim 1, comprising a procedure for identifying an opportunity window, in particular a time window in the duration time of the simulation, in which to perform said step of injecting a set of faults.

4. The method according to claim 3, wherein said procedure comprises:
simulating said application generating simulation values for all the registers of the elementary parts selected for all points of observation relative to a given effective root failure mode under examination;
selecting one or more opportunity windows within which to inject faults in an equidistributed manner, as portions of the simulation in which there is the maximum activity of the registers referred to which the elementary parts and the corresponding points of observation pertain.

5. The method according to claim 3 comprising performing a procedure which comprises, based on one or more identified opportunity windows, the storing of snapshots of the simulation circuit in different time intervals and identifying a time instant, relative to the end of a snapshot immediately before the beginning of the opportunity window, relative to which said step of injecting faults can be initiated.

6. The method according to claim 5, wherein said procedure comprises:
performing, prior to the simulation step with injection of faults, a simulation of said application without faults,
storing a plurality of snapshots of said previously performed simulation at regular intervals of time by saving the state of all the signals of the electronic circuit,
identifying from said plurality of snapshots the snapshot immediately preceding the opportunity window,
loading the states of said identified snapshot, during the simulation step with injection of faults, and
starting said step of simulation with injection of faults in the system or circuit from the final instant of the snapshot selected.

7. The method according to claim 1, wherein if the system or the electronic circuit under simulation is a system or circuit derived from an origin system or circuit already subjected to said procedure for selecting a set of effective faults relating only to effective root failure modes from the set of faults to inject, said method includes performing a procedure to select faults to re-inject that comprises comparing the elementary parts of the origin circuit or system with elementary parts obtained by applying the procedure on said derived circuit or system and, based on the result of the comparison, identifying the effective root failure modes to re-inject.

8. The method according to claim 7, wherein said procedure comprises
defining the root failure modes for the derived circuit applying said procedure to select a set of effective faults, obtaining the corresponding elementary parts and selecting the effective root failure modes to be injected;
counting the number of different elementary parts of the derived circuit with respect to the origin circuit;
calculating for a given root failure mode to be injected, a distance in percentage between a cumulative failure rate of the origin circuit and the corresponding cumulative failure rate of the derived circuit;
selecting the failure modes to re-inject into the derived circuit from the effective failure modes obtained at the preceding defining step, in particular those failure modes having a number of different elementary parts greater than a predetermined threshold or that have a distance greater than said predetermined threshold.

9. The method according to claim 8 wherein it comprises further selecting from the effective failure modes obtained at the preceding defining step the modes for which the result of the injection of the origin circuit can be re-utilized, such as those having a number of different elementary parts lower than said predetermined threshold and which have a distance less than said predetermined threshold.

10. The method according to claim 1, wherein it is included in a simulation method of said circuit or electronic system integrated in a design procedure of systems or electronic circuits, and that, in particular, it is associated, in a production process of the electronic system, with a production step at the physical level of the electronic system and also with a production step of a program that is executed on such an electronic system, according to the results of the design procedure.

11. A system for simulating faults in integrated circuits of electronic systems implementing applications under functional safety, comprising a processing system configured to operate a simulation step of said system or electronic circuit executing said application under functional safety, wherein it is configured to perform the operations of the method according to claim 1.

12. A computer program product loadable into the memory of at least one computer, said program product comprising software code portions suitable for performing the steps of the method according to claim 7 when the program product is executed on at least one computer.
